(19) United States
(12) Patent Application Publication
(10) Pub. No.: US 2018/0343689 A1
(43) Pub. Date: Nov. 29, 2018

(54) Method And Apparatus For Handling Problem Cell In Mobile Communications

(71) Applicant: MediaTek Inc., Hsinchu City (TW)

(72) Inventors: Meng-Hau Wu, Hsinchu City (TW); Shih-Chieh Liao, Hsinchu City (TW); Tsan-Kuang Su, Hsinchu City (TW)

(21) Appl. No.: 15/989,880

(22) Filed: May 25, 2018

Related U.S. Application Data
(60) Provisional application No. 62/511,371, filed on May 26, 2017.

(51) Int. Cl. H04W 76/10; H04W 76/30; H04W 28/06; H04W 76/27; H04W 36/00

(52) U.S. Cl. CPC H04W 76/10; H04W 76/30; H04W 84/042; H04W 76/27; H04W 36/00837; H04W 28/065

(57) ABSTRACT

Various solutions for problem cell handling with respect to user equipment in mobile communications are described. An apparatus may transmit user equipment (UE) capability information to a cell. The apparatus may determine the cell as a problem cell in response to no service received from the cell. The apparatus may reduce a size of the UE capability information. The apparatus may further transmit the reduced UE capability information to the problem cell.

### CROSS REFERENCE TO RELATED PATENT APPLICATION(S)

The present disclosure is part of a non-provisional application claiming the priority benefit of U.S. Patent Application No. 62/511,371, filed on 26 May 2017, the content of which is incorporated by reference in its entirety.

### TECHNICAL FIELD

The present disclosure is generally related to mobile communications and, more particularly, to problem cell handling with respect to user equipment in mobile communications.

### BACKGROUND

Unless otherwise indicated herein, approaches described in this section are not prior art to the claims listed below and are not admitted as prior art by inclusion in this section.

There are various well-developed and well-defined cellular communications technologies in telecommunications that enable wireless communications using mobile terminals, or user equipment (UE). For example, the Global System for Mobile communications (GSM) is a well-defined and commonly used communications system, which uses time division multiple access (TDMA) technology, which is a multiplex access scheme for digital radio, to send voice, video, data, and signaling information (such as a dialed telephone number) between mobile phones and cell sites. The CDMA2000 is a hybrid mobile communications 2.5G/3G (generation) technology standard that uses code division multiple access (CDMA) technology. The UMTS (Universal Mobile Telecommunications System) is a 3G mobile communications system, which provides an enhanced range of multimedia services over the GSM system. The Long-Term Evolution (LTE), as well as its derivatives such as LTE-Advanced and LTE-Advanced Pro, is a standard for high-speed wireless communication for mobile phones and data terminals. In addition, there are some newly developed next generation communication technologies such as 5th Generation (5G), New Radio (NR), Internet of Things (IoT) and Narrow Band Internet of Things (NB-IoT). These communication technologies are developed for higher speed transmission and serving for huge number of devices including machine type devices.

When a UE is powered on or moves to the coverage of a communication network, the UE may need to establish a connection (e.g., a radio resource control (RRC) connection) with a network apparatus of the communication network to acquire services. During an initial registration process, the network apparatus may transmit a UE capability enquiry message to the UE to acquire UE's capabilities for establish the connection and further data transmission. After receiving the UE capability enquiry message, the UE may transmit its UE capability information to the network apparatus. Normally, the network apparatus should transmit a response message to the UE to reconfigure the connection. However, in some circumstances, the network apparatus may not be able to handle the UE capability information due to that the supported release version of the network apparatus may be different from the supported release version of the UE. In such scenario, the network apparatus may go malfunction and not able to properly respond to the UE capability reporting message. The UE may not get services from the network apparatus.

Accordingly, it is important for the UE to detect such problem network apparatus and perform the corresponding operations in response to no services received from the problem network apparatus. Therefore, in developing communication systems, it is needed to provide proper mechanisms for handling problem network apparatus.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to problem cell handling with respect to user equipment and network apparatus in mobile communications.

In one aspect, a method may involve an apparatus determining a cell as a problem cell. The method may also involve the apparatus reducing a size of user equipment (UE) capability information. The method may further involve the apparatus transmitting the reduced UE capability information to the problem cell.

In one aspect, a method may involve an apparatus transmitting user equipment (UE) capability information to a cell. The method may also involve the apparatus determining the cell as a problem cell in response to no service received from the cell. The method may further involve the apparatus performing a reaction to the problem cell.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a block diagram of an example communication apparatus and an example network apparatus in accordance with an implementation of the present disclosure.

FIG. 3 is a flowchart of an example process in accordance with an implementation of the present disclosure.

FIG. 4 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to problem cell handling with respect to user equipment in mobile communications. According to the present disclosure, a number of possible solutions may be implemented separately or jointly. That is, although these possible solutions may be described below separately, two or more of these possible solutions may be implemented in one combination or another.

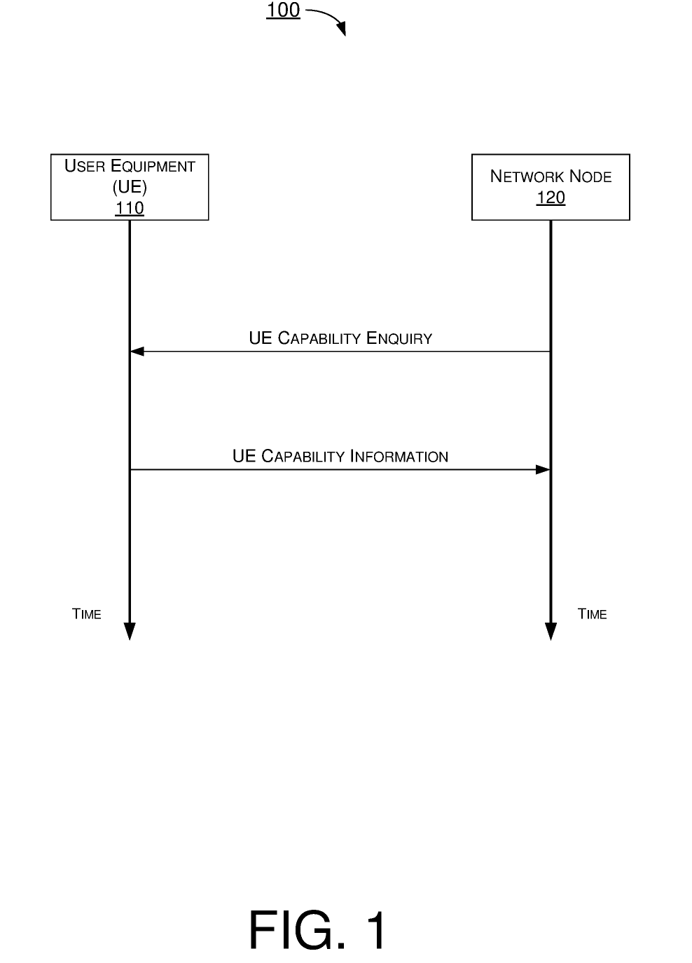

FIG. 1 illustrates an example scenario 100 under schemes in accordance with implementations of the present disclosure. Scenario 100 involves a user equipment (UE) 110 and a network apparatus 120, which may be a part of a wireless communication network (e.g., a Long Term Evolution (LTE) network, an LTE-Advanced network, an LTE-Advanced Pro network, a 5th Generation (5G) network, a New Radio (NR) network, an Internet of Things (IoT) network or a Narrow Band Internet of Things (NB-IoT) network). Network apparatus 120 may be implemented as a cell, a base station, an evolved node B (eNB) or a gNB of the wireless communication network. When UE 110 is powered on or moves to the coverage of network apparatus 120, UE 110 may be configured to establish a radio resource control (RRC) connection with network apparatus 120 to acquire services. During an initial registration process, network apparatus 120 may be configured to transmit a UE capability enquiry message to UE 110 to acquire UE's capabilities. After receiving the UE capability enquiry message, UE 110 may be configured to transmit its UE capability information to network apparatus 120. Normally, network apparatus 120 may be configured to transmit an RRC connection reconfiguration message to UE 110 to reconfigure the RRC connection. However, as 3rd Generation Partnership Project (3GPP) release version (e.g., LTE or NR) goes higher, more and more features may be added and supported by the UE. UE capability information may become larger and complicated. In a case that the network apparatus may not be updated as fast as the UE, the network apparatus may not be compatible with the UE. For example, when the size of the UE capability information exceeds an expected value supported by some network apparatus, such network apparatus may be unable to deal with the UE capability information. The RRC connection may not be set up or maintained for such network apparatus. The UE may be unable to receive services from such network apparatus.

In some implementations, the network apparatus which cannot support large size UE capability information may be classified as problem cells by the UE. The UE may be configured to detect those problem cells in accordance with implementations of the present disclosure. Specifically, when the UE transmits UE capability information to a cell, the cell may be determined as a problem cell in an event that no service can be received from the cell. For example, the UE may be configured to transmit the UE capability information to a cell. In an event that the cell transmits a connection release message (e.g., an RRC connection release message) to the UE, the UE may be configured to determine the cell as the problem cell in response to receiving the connection release message. The UE may also determine the cell as the problem cell in an event that the same behavior repeats several times. Alternatively, when the UE transmits the UE capability information to a cell, in an event that the cell transmits a detach request message to the UE, the UE may be configured to determine the cell as the problem cell in response to receiving the detach request message. The UE may also determine the cell as the problem cell in an event that the same behavior repeats several times. Alternatively, when the UE transmits the UE capability information to a cell, in an event that the cell does not transmit a response message (e.g., an RRC connection reconfiguration message) to the UE, the UE may be configured to determine the cell as the problem cell in response to no response received from the cell. The UE may initiate a timer after transmitting the UE capability information to the cell. In an event that no response or no service is received from the cell before the expiration of the timer, the UE may determine the cell as the problem cell in response to the expiration of the timer.

In some implementations, the UE may be configured to perform local release of a connection with the problem cell in response to the expiration of the timer or no response received from the problem cell. The UE may be configured to establish a new connection with the problem cell.

In some implementations, the UE may be configured to determine a cell as a problem cell according to some pre-stored information. The pre-stored information may comprise, for example and without limitation, a mobile country code (MCC), a mobile network code (MNC), a public land mobile network (PLMN) or cell information. Specifically, the pre-stored information may indicate whether a cell can support the large size of UE capability information or the supported release version of a cell. For example, the UE may be powered on in a country, in a case that the UE is aware of that the cells in that country do not support latest release version, the UE may be able to determine that the cells belong to problem cells. The UE may pre-store the cell information (e.g., MCC, MNC, PLMN or cell identify) of the cells which cannot handle the large size UE capability information. Accordingly, the UE may be able to recognize those cells and determine those cells as the problem cells.

In some implementations, after determining a cell as a problem cell, the UE may be configured to reduce the size of the UE capability information and transmit the reduced UE capability information to the problem cell again. Specifically, since the problem cell cannot handle the large size UE capability information, the UE may reduce the size of the UE capability information by removing some information or some supported features from the UE capability information. For example, the UE may reduce the size of the UE capability information by removing at least one carrier aggregation (CA) band combination from the UE capability information. CA is supported in LTE-Advanced in order to increase the bandwidth and the data rate. In a case that the UE is capable of supporting CA transmission, the UE may need to report the supported CA band combinations to the cell. Accordingly, the UE may remove or filter out some supported CA band combinations (e.g., 5 sets of CA band combinations) to reduce the size of the UE capability information.

Alternatively, the UE may reduce the size of the UE capability information by carrying pre-determined CA band combinations in the UE capability information. The pre-determined CA band combinations may be a sub-set of the whole CA band combinations supported by the UE and may have a smaller size.

Alternatively, the UE may reduce the size of the UE capability information by turning off at least one CA capability. For example, the UE may be configured to turn off the uplink CA capability, the downlink CA capability, or the whole CA capability. When the CA capability is turned off, the UE may not need to report the CA band combinations in the UE capability information. The size of the UE capability information may be reduced.

Alternatively, the UE may reduce the size of the UE capability information by removing at least one UE supported feature from the UE capability information. For example, the UE may downgrade the supported release version (e.g., from Release-13 to Release-12). The UE may support less features in the lower release version. Accordingly, fewer information may need to be reported in the UE capability information. The size of the UE capability information may also be reduced. In another example, the UE may remove some optional features from the UE capability information. The optional features are not mandatory for UE's capability requirements. Therefore, the UE may not report those optional features to reduce the size of the UE capability information.

In addition to reducing the size of the UE capability information and transmitting the reduced UE capability information again, the UE may also be configured to perform other reactions in response to no service received from the cell. Specifically, after determining a cell as a problem cell, the UE may be further configured to perform local release of a connection with the problem cell. For example, the UE may initiate a timer after transmitting the UE capability information. In response to no response received from the problem cell and the expiration of the timer, the UE may be configured to locally release the connection which has been established with the problem cell. Since the connection is unable to be completed between the UE and the problem cell, the UE may local release the connection to release the radio resource and avoid residing on the problem cell.

The UE may be further configured to adjust a priority of the problem cell. Since the problem cell may not able to handle the large size UE capability information and the UE may not receive services from the problem cell, the UE may be configured to lower the priority of the problem cell so that the problem cell may be hard to be selected by the UE. For example, the UE may adjust at least one of the reselection priority, the frequency offset or the cell offset of the problem cell to make the problem cell harder to be selected. The UE may also initiate a timer to count the priority recover time. When the timer is expired, the UE may recover the priority or offset of the problem cell. The timer may be set, for example, from milliseconds to days.

The UE may be further configured to bar the problem cell. Since the problem cell may not able to handle the large size UE capability information and the UE may not receive services from the problem cell, the UE may be configured not to select the problem cell. For example, when a cell is determined as a problem cell, the UE may add the problem cell into a forbidden list. The UE may also initiate a timer to count the barring time. When the timer is expired, the UE may remove the problem cell from the forbidden list. The timer may be set, for example, from milliseconds to days.

In some implementations, after determining a cell as a problem cell, the UE may be configured to store or keep the cell information of the problem cell for a period of time. For example, the UE may store the cell identity of the problem cell. More than one problem cells may be stored by the UE. More than one radio access technologies (RAT) of the problem cells may also be stored by the UE. The UE may maintain at least one forbidden list or blacklist for the problem cells. The UE may initiate a timer for each problem cell or initiate a timer for the forbidden list or the blacklist. When the timer is expired, the UE may determine the problem cell as a normal cell or remove the problem cell from the forbidden list or the blacklist. In another example, when one of the problem cells is reverted to a normal cell, the UE may revert a part of or all the remaining problem cells to normal cells.

In some implementations, when the timer is expired, the UE may be configured to re-transmit the UE capability information to the problem cell. In an event that the UE receives a normal response message (e.g., an RRC connection reconfiguration message) or receives services from the problem cell, the UE may determine the problem cell as a normal cell. Alternatively, when the UE reselects to the problem cell again due to strong signal strength from the problem cell, the UE may also be configured to re-transmit the UE capability information to the problem cell. Similarly, the UE may determine the problem cell as a normal cell in response to receiving service from the problem cell.

In some implementations, when the UE reselects or is handed over to a normal cell from a problem cell, the normal cell may not enquiry UE capability (e.g., transmit a UE capability enquiry message to the UE) and may have no information about the UE's capability. In response to such scenario, the UE may be configured to trigger a UE capability transfer procedure. For example, the UE may detach from the normal cell and attach to the normal cell again to trigger the normal cell to acquire the UE capability information. Alternatively, the UE may switch on a flight mode and switch off the flight mode to re-initiate the initial registration process. Alternatively, the UE may power off and power on again to perform the initial registration process. When the UE reselects or is handed over to a problem cell from a normal cell, the UE may be configured to detach from the problem cell and react in accordance with the implementations as described above.

### Illustrative Implementations

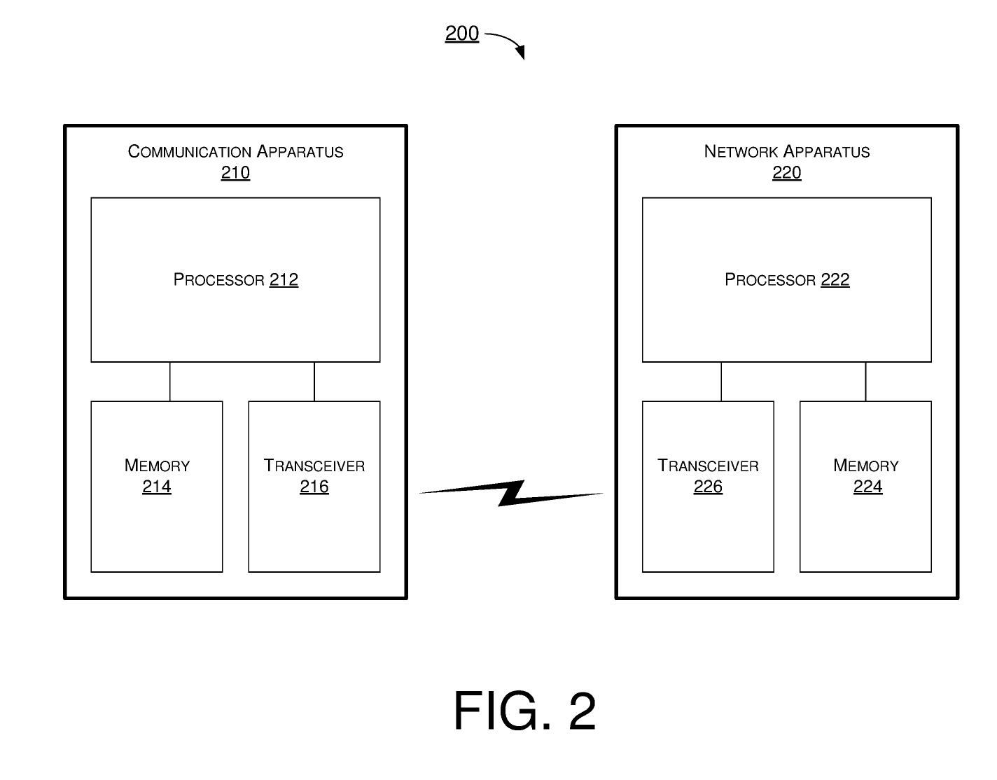

FIG. 2 illustrates an example communication apparatus 210 and an example network apparatus 220 in accordance with an implementation of the present disclosure. Each of communication apparatus 210 and network apparatus 220 may perform various functions to implement schemes, techniques, processes and methods described herein pertaining to problem cell handling with respect to user equipment and network apparatus in wireless communications, including scenario 100 described above as well as processes 300 and 400 described below.

Communication apparatus 210 may be a part of an electronic apparatus, which may be a user equipment (UE) such as a portable or mobile apparatus, a wearable apparatus, a wireless communication apparatus or a computing apparatus. For instance, communication apparatus 210 may be implemented in a smartphone, a smartwatch, a personal digital assistant, a digital camera, or a computing equipment such as a tablet computer, a laptop computer or a notebook computer. Communication apparatus 210 may also be a part of a machine type apparatus, which may be an IoT or NB-IoT apparatus such as an immobile or a stationary apparatus, a home apparatus, a wire communication apparatus or a computing apparatus. For instance, communication apparatus 210 may be implemented in a smart thermostat, a smart fridge, a smart door lock, a wireless speaker or a home control center. Alternatively, communication apparatus 210 may be implemented in the form of one or more integrated-circuit (IC) chips such as, for example and without limitation, one or more single-core processors, one or more multi-core processors, or one or more complex-instruction-set-computing (CISC) processors. Communication apparatus 210 may include at least some of those components shown in FIG. 2 such as a processor 212, for example. communication apparatus 210 may further include one or more other components not pertinent to the proposed scheme of the present disclosure (e.g., internal power supply, display device and/or user interface device), and, thus, such component(s) of communication apparatus 210 are neither shown in FIG. 2 nor described below in the interest of simplicity and brevity.

Network apparatus 220 may be a part of an electronic apparatus, which may be a network node such as a base station, a small cell, a router or a gateway. For instance, network apparatus 220 may be implemented in an eNodeB in an LTE, LTE-Advanced or LTE-Advanced Pro network or in a gNB in a 5G, NR, IoT or NB-IoT network. Alternatively, network apparatus 220 may be implemented in the form of one or more IC chips such as, for example and without limitation, one or more single-core processors, one or more multi-core processors, or one or more CISC processors. Network apparatus 220 may include at least some of those components shown in FIG. 2 such as a processor 222, for example. Network apparatus 220 may further include one or more other components not pertinent to the proposed scheme of the present disclosure (e.g., internal power supply, display device and/or user interface device), and, thus, such component(s) of network apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks including power consumption reduction in a device (e.g., as represented by communication apparatus 210) and a network (e.g., as represented by network apparatus 220) in accordance with various implementations of the present disclosure.

In some implementations, communication apparatus 210 may also include a transceiver 216 coupled to processor 212 and capable of wirelessly transmitting and receiving data. In some implementations, communication apparatus 210 may further include a memory 214 coupled to processor 212 and capable of being accessed by processor 212 and storing data therein. In some implementations, network apparatus 220 may also include a transceiver 226 coupled to processor 222 and capable of wirelessly transmitting and receiving data. In some implementations, network apparatus 220 may further include a memory 224 coupled to processor 222 and capable of being accessed by processor 222 and storing data therein. Accordingly, communication apparatus 210 and network apparatus 220 may wirelessly communicate with each other via transceiver 216 and transceiver 226, respectively. To aid better understanding, the following description of the operations, functionalities and capabilities of each of communication apparatus 210 and network apparatus 220 is provided in the context of a mobile communication environment in which communication apparatus 210 is implemented in or as a communication apparatus or a UE and network apparatus 220 is implemented in or as a network node of a communication network.

In some implementations, when communication apparatus 210 is powered on or moves to the coverage of network apparatus 220, processor 212 may be configured to establish a radio resource control (RRC) connection with network apparatus 220 to acquire services. During an initial registration process, processor 212 may receive, via transceiver 216, a UE capability enquiry message from network apparatus 220. After receiving the UE capability enquiry message, processor 212 may be configured to transmit its UE capability information to network apparatus 220.

In some implementations, network apparatus 220 may not support large size UE capability information and may be classified as a problem cell by communication apparatus 210. Processor 212 may be configured to detect the problem cell in accordance with implementations of the present disclosure. Specifically, processor 212 may determine network apparatus 220 as a problem cell in an event that no service can be received from network apparatus 220. For example, processor 212 may be configured to transmit the UE capability information to network apparatus 220. In an event that network apparatus 220 transmits a connection release message (e.g., an RRC connection release message) to communication apparatus 210, processor 212 may be configured to determine network apparatus 220 as the problem cell in response to receiving the connection release message. Processor 212 may also determine network apparatus 220 as the problem cell in an event that the same behavior repeats several times.

In some implementations, when processor 212 transmits the UE capability information to network apparatus 220, in an event that network apparatus 220 transmits a detach request message to communication apparatus 210, processor 212 may be configured to determine network apparatus 220 as the problem cell in response to receiving the detach request message. Processor 212 may also determine the cell as the problem cell in an event that the same behavior repeats several times.

In some implementations, when processor 212 transmits the UE capability information to network apparatus 220, in an event that network apparatus 220 does not transmit a response message (e.g., an RRC connection reconfiguration message) to communication apparatus 210, processor 212 may be configured to determine network apparatus 220 as the problem cell in response to no response received from network apparatus 220. Processor 212 may initiate a timer after transmitting the UE capability information to network apparatus 220. In an event that no response or no service is received from network apparatus 220 before the expiration of the timer, processor 212 may determine network apparatus 220 as the problem cell in response to the expiration of the timer.

In some implementations, processor 212 may be configured to perform local release of a connection with network apparatus 220 in response to the expiration of the timer or no response received from network apparatus 220. Processor 212 may be configured to establish a new connection with network apparatus 220.

In some implementations, processor 212 may be configured to determine a cell as a problem cell according to some pre-stored information. The pre-stored information may comprise, for example and without limitation, a mobile country code (MCC), a mobile network code (MNC), a public land mobile network (PLMN) or cell information. Specifically, the pre-stored information may indicate whether a cell can support the large size of UE capability information or the supported release version of a cell. For example, processor 212 may be powered on in a country, in a case that processor 212 is aware of that the cells in that country do not support latest release version, processor 212 may be able to determine that the cells belong to problem cells. Processor 212 may pre-store the cell information (e.g., MCC, MNC, PLMN or cell identify) of the cells which cannot handle the large size UE capability information in memory 214. Accordingly, processor 212 may be able to recognize those cells and determine those cells as the problem cells.

In some implementations, after determining network apparatus 220 as a problem cell, processor 212 may be configured to reduce the size of the UE capability information and transmit the reduced UE capability information to network apparatus 220 again. Specifically, since network apparatus 220 cannot handle the large size UE capability information, processor 212 may reduce the size of the UE capability information by removing some information or some supported features from the UE capability information. For example, processor 212 may reduce the size of the UE capability information by removing at least one carrier aggregation (CA) band combination from the UE capability information. In a case that communication apparatus 210 is capable of supporting CA transmission, processor 212 may need to report the supported CA band combinations to network apparatus 220. Accordingly, processor 212 may remove or filter out some supported CA band combinations (e.g., 5 sets of CA band combinations) to reduce the size of the UE capability information.

In some implementations, processor 212 may reduce the size of the UE capability information by carrying pre-determined CA band combinations in the UE capability information. The pre-determined CA band combinations may be a sub-set of the whole CA band combinations supported by communication apparatus 210 and may have a smaller size.

In some implementations, processor 212 may reduce the size of the UE capability information by turning off at least one CA capability. For example, processor 212 may be configured to turn off the uplink CA capability, the downlink CA capability, or the whole CA capability. When the CA capability is turned off, processor 212 may not need to report the CA band combinations in the UE capability information. The size of the UE capability information may be reduced.

In some implementations, processor 212 may reduce the size of the UE capability information by removing at least one UE supported feature from the UE capability information. For example, processor 212 may downgrade the supported release version (e.g., from Release-13 to Release-12). Communication apparatus 210 may support less features in the lower release version. Accordingly, fewer information may need to be reported in the UE capability information. The size of the UE capability information may also be reduced.

In some implementations, processor 212 may remove some optional features from the UE capability information. The optional features are not mandatory for UE's capability requirements. Therefore, processor 212 may not report those optional features to reduce the size of the UE capability information.

In some implementations, processor 212 may also be configured to perform other reactions in response to no service received from network apparatus 220. Specifically, after determining network apparatus 220 as a problem cell, processor 212 may be further configured to perform local release of a connection with the problem cell. For example, processor 212 may initiate a timer after transmitting the UE capability information. In response to no response received from the problem cell and the expiration of the timer, processor 212 may be configured to locally release the connection which has been established with the problem cell. Since the connection is unable to be completed between communication apparatus 210 and network apparatus 220, processor 212 may local release the connection to release the radio resource and avoid residing on network apparatus 220.

In some implementations, processor 212 may be further configured to adjust a priority of the problem cell. Since the problem cell may not able to handle the large size UE capability information and communication apparatus 210 may not receive services from the problem cell, processor 212 may be configured to lower the priority of the problem cell so that the problem cell may be hard to be selected by processor 212. For example, processor 212 may adjust at least one of the reselection priority, the frequency offset or the cell offset of the problem cell to make the problem cell harder to be selected. Processor 212 may also initiate a timer to count the priority recover time. When the timer is expired, processor 212 may recover the priority or offset of the problem cell. The timer may be set, for example, from milliseconds to days.

In some implementations, processor 212 may be further configured to bar the problem cell. Since the problem cell may not able to handle the large size UE capability information and communication apparatus 210 may not receive services from the problem cell, processor 212 may be configured not to select the problem cell. For example, when network apparatus 220 is determined as a problem cell, processor 212 may add network apparatus 220 into a forbidden list. Processor 212 may also initiate a timer to count the barring time. When the timer is expired, processor 212 may remove network apparatus 220 from the forbidden list. The timer may be set, for example, from milliseconds to days.

In some implementations, after determining network apparatus 220 as a problem cell, processor 212 may be configured to store or keep the cell information of network apparatus 220 for a period of time. For example, processor 212 may store the cell identity of network apparatus 220. More than one problem cells may be stored by processor 212. More than one radio access technologies (RAT) of the problem cells may also be stored by processor 212. Processor 212 may maintain at least one forbidden list or blacklist for the problem cells. Processor 212 may initiate a timer for each problem cell or initiate a timer for the forbidden list or the blacklist. When the timer is expired, processor 212 may determine the problem cell as a normal cell or remove the problem cell from the forbidden list or the blacklist. In some implementations, when one of the problem cells is reverted to a normal cell, processor 212 may revert a part of or all the remaining problem cells to normal cells.

In some implementations, when the timer is expired, processor 212 may be configured to re-transmit the UE capability information to network apparatus 220. In an event that processor 212 receives a normal response message (e.g., an RRC connection reconfiguration message) or receives services from network apparatus 220, processor 212 may determine network apparatus 220 as a normal cell.

In some implementations, processor 212 reselects to the problem cell again due to strong signal strength from the problem cell, processor 212 may also be configured to re-transmit the UE capability information to the problem cell. Similarly, processor 212 may determine the problem cell as a normal cell in response to receiving service from the problem cell.

In some implementations, when communication apparatus 210 reselects or is handed over to a normal cell from a problem cell, the normal cell may not enquiry UE capability (e.g., transmit a UE capability enquiry message to the UE) and may have no information about the UE's capability. In response to such scenario, processor 212 may be configured to trigger a UE capability transfer procedure. For example, processor 212 may detach from the normal cell and attach to the normal cell again to trigger the normal cell to acquire the UE capability information. In some implementations, processor 212 may switch on a flight mode and switch off the flight mode to re-initiate the initial registration process. In some implementations, processor 212 may power off and power on again to perform the initial registration process. When communication apparatus 210 reselects or is handed over to a problem cell from a normal cell, processor 212 may be configured to detach from the problem cell and react in accordance with the implementations as described above.

### Illustrative Processes

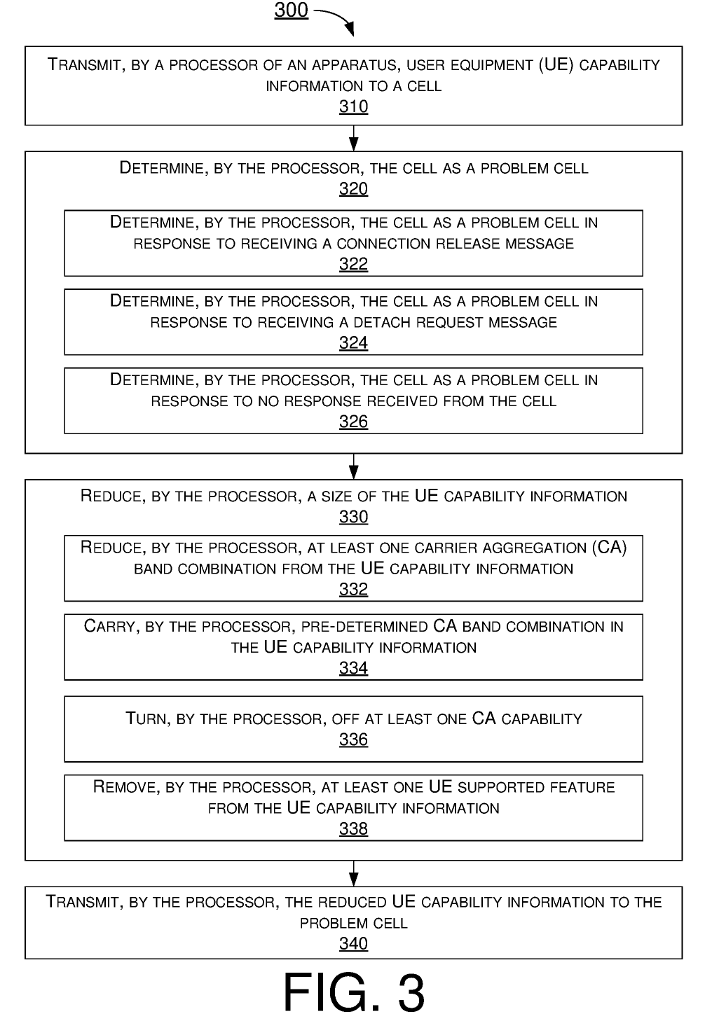

FIG. 3 illustrates an example process 300 in accordance with an implementation of the present disclosure. Process 300 may represent an aspect of implementing the proposed concepts and schemes such as one or more of the various schemes described above with respect to FIG. 1 and FIG. 2. More specifically, process 300 may represent an aspect of the proposed concepts and schemes pertaining to problem cell handling in mobile communication networks and systems. For instance, process 300 may be an example implementation, whether partially or completely, of the proposed schemes described above for problem cell handling in mobile communication networks and systems. Process 300 may include one or more operations, actions, or functions as illustrated by one or more of blocks 310, 320, 330 and 340 as well as sub-blocks 322, 324, 326, 332, 334, 336 and 338. Although illustrated as discrete blocks, various blocks of process 300 may be divided into additional blocks, combined into fewer blocks, or eliminated, depending on the desired implementation. Moreover, the blocks/sub-blocks of process 300 may be executed in the order shown in FIG. 3 or, alternatively in a different order. The blocks/sub-blocks of process 300 may be executed iteratively. Process 300 may be implemented by communication apparatus 210 as well as any variations thereof. Solely for illustrative purposes and without limiting the scope, process 300 is described below in the context of communication apparatus 210 being a UE and network apparatus 220 being a cell. Process 300 may begin at block 310.

At 310, process 300 may involve processor 212 of apparatus 210 transmitting, via transceiver 216, user equipment (UE) capability information to a cell. Process 300 may proceed from 310 to 320.

At 320, process 300 may involve processor 212 determining the cell as a problem cell. The number of operations may be represented by sub-blocks 322 and 326. Process 300 may further proceed from 320 to 330.

At 322, process 300 may involve processor 212 determining the cell as a problem cell in response to receiving a connection release message.

At 324, process 300 may involve processor 212 determining the cell as a problem cell in response to receiving a detach request message.

At 326, process 300 may involve processor 212 determining the cell as a problem cell in response to no response received from the cell. Process 300 may further involve processor 212 performing local release of a connection with the problem cell. Process 300 may involve processor 212 establishing a new connection with the problem cell.

At 330, process 300 may involve processor 212 reducing a size of the UE capability information. The number of operations may be represented by sub-blocks 332 and 338. Process 300 may further proceed from 330 to 340.

At 332, process 300 may involve processor 212 removing at least one carrier aggregation (CA) band combination from the UE capability information.

At 334, process 300 may involve processor 212 carrying pre-determined CA band combinations in the UE capability information.

At 336, process 300 may involve processor 212 turning off at least one CA capability.

At 338, process 300 may involve processor 212 removing at least one UE supported feature from the UE capability information.

At 340, process 300 may involve processor 212 transmitting, via transceiver 216, the reduced UE capability information to the problem cell.

In some implementations, process 300 may further involve processor 212 initiating a timer and determining the cell as a problem cell in response to expiration of the timer.

In some implementations, process 300 may further involve processor 212 determining the cell as the problem cell according to pre-stored information. The pre-stored information may comprise at least one of a mobile country code (MCC), a mobile network code (MNC), a public land mobile network (PLMN) or cell information.

In some implementations, process 300 may further involve processor 212 storing cell information of the problem cell.

In some implementations, process 300 may further involve processor 212 initiating a timer for the problem cell and determining the problem cell as a normal cell in response to expiration of the timer.

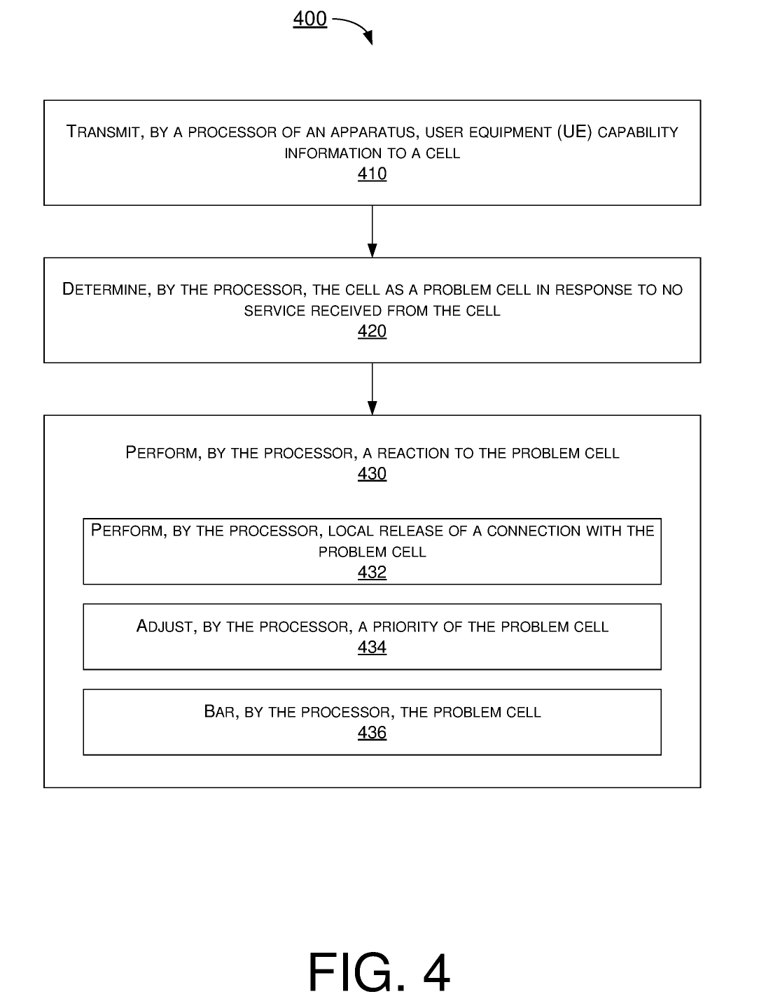

FIG. 4 illustrates an example process 400 in accordance with an implementation of the present disclosure. Process 400 may represent an aspect of implementing the proposed concepts and schemes such as one or more of the various schemes described above with respect to FIG. 1 and FIG. 2. More specifically, process 400 may represent an aspect of the proposed concepts and schemes pertaining to problem cell handling in mobile communication networks and systems. For instance, process 400 may be an example implementation, whether partially or completely, of the proposed schemes described above for problem cell handling in mobile communication networks and systems. Process 400 may include one or more operations, actions, or functions as illustrated by one or more of blocks 410, 420, 430, 440, 442 and 444. Although illustrated as discrete blocks, various blocks of process 400 may be divided into additional blocks, combined into fewer blocks, or eliminated, depending on the desired implementation. Moreover, the blocks/sub-blocks of process 400 may be executed in the order shown in FIG. 4 or, alternatively in a different order. The blocks/sub-blocks of process 400 may be executed iteratively. Process 400 may be implemented by communication apparatus 210 as well as any variations thereof. Solely for illustrative purposes and without limiting the scope, process 400 is described below in the context of communication apparatus 210 being a UE and network apparatus 220 being a cell. Process 400 may begin at block 410.

At 410, process 400 may involve processor 212 of apparatus 210 transmitting, via transceiver 216, user equipment (UE) capability information to a cell. Process 400 may proceed from 410 to 420.

At 420, process 400 may involve processor 212 determining the cell as a problem cell in response to no service received from the cell. Process 400 may proceed from 420 to 430.

At 430, process 400 may involve processor 212 performing a reaction to the problem cell. The number of operations may be represented by sub-blocks 432 and 436. Process 400 may proceed from 420 to at least one of operations represented by blocks 432 to 436.

At 432, process 400 may involve processor 212 performing local release of a connection with the problem cell.

At 434, process 400 may involve processor 212 adjusting a priority of the problem cell.

At 436, process 400 may involve processor 212 barring the problem cell.

In some implementations, in determining the cell as a problem cell, process 400 may involve processor 212 determining the cell as a problem cell in response to receiving a connection release message.

In some implementations, in determining the cell as a problem cell, process 400 may involve processor 212 determining the cell as a problem cell in response to receiving a detach request message.

In some implementations, in determining the cell as a problem cell, process 400 may involve processor 212 determining the cell as a problem cell in response to no response received from the cell. Process 400 may further involve processor 212 performing local release of a connection with the problem cell. Process 400 may involve processor 212 establishing a new connection with the problem cell.

In some implementations, process 400 may further involve processor 212 re-transmitting, via transceiver 216, the UE capability information to the problem cell and determining the problem cell as a normal cell in response to receiving service from the problem cell.

In some implementations, process 400 may further involve processor 212 triggering a UE capability transfer procedure in response to reselecting or handover to a normal cell. The triggering may comprise performing at least one of detaching from and attaching to the normal cell, switching on and switching off a flight mode, or powering off and powering on in a case that the network side doesn't enquiry the UE capability in the normal cell.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of an apparatus, a cell as a problem cell;
reducing, by the processor, a size of user equipment (UE) capability information; and
transmitting, by the processor, the reduced UE capability information to the problem cell.

2. The method of claim 1, wherein the reducing comprises removing at least one carrier aggregation (CA) band combination from the UE capability information.

3. The method of claim 1, wherein the reducing comprises carrying pre-determined carrier aggregation (CA) band combinations in the UE capability information.

4. The method of claim 1, wherein the reducing comprises turning off at least one carrier aggregation (CA) capability.

5. The method of claim 1, wherein the reducing comprises removing at least one UE supported feature from the UE capability information.

6. The method of claim 1, further comprising:
transmitting, by the processor, UE capability information to the cell; and
receiving, by the processor, a connection release message from the cell,
wherein the determining comprises determining the cell as the problem cell in response to receiving the connection release message.

7. The method of claim 1, further comprising:
transmitting, by the processor, UE capability information to the cell; and
receiving, by the processor, a detach request message from the cell,
wherein the determining comprises determining the cell as the problem cell in response to receiving the detach request message.

8. The method of claim 1, further comprising:
transmitting, by the processor, UE capability information to the cell; and
initiating, by the processor, a timer,
wherein the determining comprises determining the cell as the problem cell in response to expiration of the timer.

9. The method of claim 1, further comprising:
transmitting, by the processor, UE capability information to the cell,
wherein the determining comprises determining the cell as the problem cell in response to no response received from the cell.

10. The method of claim 1, wherein the determining comprises determining the cell as the problem cell according to pre-stored information.

11. The method of claim 10, wherein the pre-stored information comprises at least one of a mobile country code (MCC), a mobile network code (MNC), a public land mobile network (PLMN) or cell information.

12. The method of claim 1, further comprising:
storing, by the processor, cell information of the problem cell.

13. The method of claim 1, further comprising:
initiating, by the processor, a timer for the problem cell; and
determining, by the processor, the problem cell as a normal cell in response to expiration of the timer.

14. A method, comprising:
transmitting, by a processor of an apparatus, user equipment (UE) capability information to a cell;
determining, by the processor, the cell as a problem cell in response to no service received from the cell; and
performing, by the processor, a reaction to the problem cell.

15. The method of claim 14, wherein the performing comprises performing local release of a connection with the problem cell.

16. The method of claim 14, wherein the performing comprises adjusting a priority of the problem cell.

17. The method of claim 14, wherein the performing comprises barring the problem cell.

18. The method of claim 14, further comprising:
re-transmitting, by the processor, the UE capability information to the problem cell; and
determining, by the processor, the problem cell as a normal cell in response to receiving service from the problem cell.

19. The method of claim 14, further comprising:
triggering, by the processor, a UE capability transfer procedure in response to reselecting or handover to a normal cell.

20. The method of claim 19, wherein the triggering comprises performing at least one of detaching from and attaching to the normal cell, switching on and switching off a flight mode, or powering off and powering on.
